(19) United States
(12) Patent Application Publication
(10) Pub. No.: US 2024/0404063 A1
(43) Pub. Date: Dec. 5, 2024

(54) VIDEO/IMAGE REFRAMING TECHNIQUES BASED ON GAZE DETECTION

(71) Applicant: APPLE INC., Cupertino, CA (US)

(72) Inventors: Abhishek SINGH, Los Altos, CA (US); Vinay SHARMA, Palo Alto, CA (US); Aman RAJ, San Jose, CA (US); Tim KO, Santa Clara, CA (US); Shuang GAO, Sunnyvale, CA (US)

(21) Appl. No.: 18/651,144

(22) Filed: Apr. 30, 2024

Related U.S. Application Data
(60) Provisional application No. 63/505,783, filed on Jun. 2, 2023.

(51) Int. Cl. G06T 7/10; G06T 7/70; G06V 40/16

(52) U.S. Cl. CPC G06T 7/10; G06T 7/70; G06V 40/161; G06T 2207/20132; G06T 2207/30201

(57) ABSTRACT

Techniques are disclosed for framing images and/or video streams. Such techniques may include performing face detection on an image, determining a gaze direction within image content associated with a detected face, and defining a cropping window for the image based on the detected face and the determined gaze direction of the detected face. Thereafter, the image may be cropped according to the cropping window.

### CLAIMS FOR PRIORITY

The present disclosure benefits from priority conferred by application Ser. No. 63/505,783, filed Jun. 2, 2023, entitled “Video/Image Reframing Techniques Based On Gaze Detection,” the disclosures of which are incorporated herein in their entireties.

### BACKGROUND

The present disclosure relates to video and/or image processing techniques in which video/image is reframed based on locations of human subjects in captured content.

Many modern personal electronic devices support exchange of images and/or videos between devices. Digital cameras are offered on many personal computers, tablet computers, smartphones, and other personal electronic devices, which all users of those devices to capture local image/video data for storage and/or exchange. Thus, device users can capture images for local storage and review, stream video to social messaging platforms, and conduct video conferences with other users.

Many such systems provide tools to assist users to compose images and/or video. For example, systems may detect human faces or other objects within images or video and reframe images using detected faces as a point of reference. For example, many video conferencing systems today crop the camera field of view in order to keep faces framed in the center of the resulting video stream. Such systems have a limitation that, in crowded scenes, they tend to include faces of non-participants, which may be present in background content, in the reframing. This creates an un-pleasant video conferencing experience where along with the main participant in the call, any person simply walking in the background (and not participating in the call) will also get tracked and framed.

### BRIEF DESCRIPTION OF THE DRAWINGS

FIG. 1 illustrates a video exchange system suitable for use with embodiments of the present disclosure.

FIG. 2 illustrates a method according to an embodiment of the present disclosure.

FIG. 3(a) illustrates an exemplary frame of video that may be processed by the method of FIG. 2. FIG. 3(b) illustrates an exemplary cropped frame that may be generated from the method of FIG. 2.

FIG. 4 illustrates a method according to another embodiment of the present disclosure.

FIG. 5(a) illustrates an exemplary frame of video that may be processed by the method of FIG. 4. FIG. 5(b) illustrates a cropped frame that may be generated from the method 400 of FIG. 4.

FIG. 6 illustrates another method according to an embodiment of the present disclosure.

FIG. 7 is a block diagram of processing infrastructure of a terminal according to an aspect of the present disclosure.

FIG. 8 illustrates a processing pipeline that video may traverse among the processors of FIG. 7.

### DETAILED DESCRIPTION

Embodiments of the present disclosure provide techniques for framing images and/or video streams. Such techniques may include performing face detection on an image, determining a gaze direction within image content associated with a detected face, and defining a cropping window for the image based on the detected face and the determined gaze direction of the detected face. Thereafter, the image may be cropped according to the cropping window.

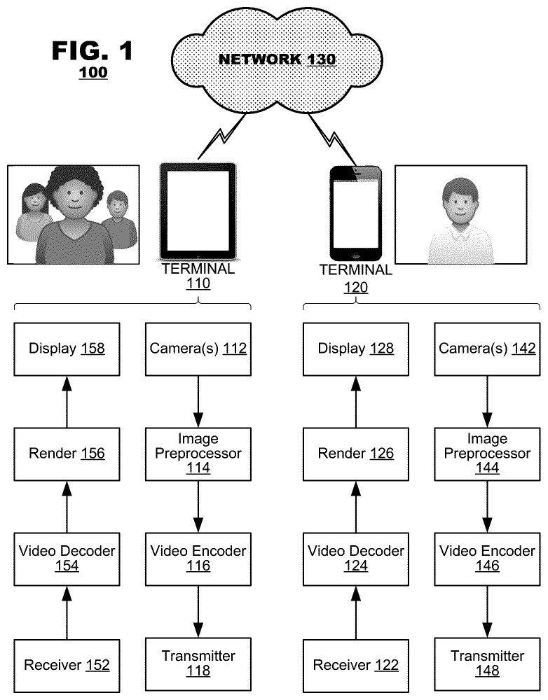

FIG. 1 illustrates a video exchange system 100 that includes a pair of terminal devices 110, 120 provided in mutual communication over a network 130. The terminals 110, 120 may exchange coded video either unidirectionally or bidirectionally over the network 130. For unidirectional video exchange, a first terminal 110 may possess a camera 112 that generates a video stream representing locally-captured video content, an image preprocessor 114 that processes the video stream for transmission to a remote terminal 120, a video encoder 116 that codes input video into a coded representation that is bandwidth compressed in comparison to the video stream output by the camera 112, and a transmitter 118 that formats coded video data from the video encoder 116 for transmission to the remote terminal 120. The second terminal 120 may possess elements that recover a video stream from the coded video data transmitted to it by the first terminal 110. For example, the second terminal 120 may include a receiver 122 that recovered coded video data from the data received from the network 130, a video decoder 124 that inverts coding operations applied by the video encoder 116, a rendering unit 126 that prepares decoded video data for output at the second terminal 120, and a display system 128 that displays the recovered video content. These components carry video data in one direction through the system 100 from the first terminal 110 to the second terminal 120.

For bidirectional video exchange, the second terminal 120 and the first terminal 110 may perform these operations for a second video stream that progresses in a second direction through the system, from the second terminal 120 to the first terminal 110. In addition to the components 112-118 and 122-128 already discussed, the second terminal 120 may possess its own a camera 142 that generates a second video stream representing video content captured locally at the second terminal 120, an image preprocessor 144 that processes the second video stream for transmission to the first terminal 110, a video encoder 146 that codes input video into a coded representation that is bandwidth compressed in comparison to the video stream output by the camera 142, and a transmitter 148 that formats coded video data from the video encoder 146 for transmission to the first terminal 110. The first terminal 110 may possess elements that recover a video stream from the coded video data transmitted to it by the second terminal 120 such as a receiver 152 that recovers coded video data from the data received from the network 130, a video decoder 154 that inverts coding operations applied by the video encoder 146, a rendering unit 156 that prepares decoded video data for output at the second terminal 110, and a display system 156 that displays the recovered video content. Thus, the system 100 supports bidirectional communication between the two terminals 110, 120.

Although FIG. 1 illustrates exemplary terminals 110, 120 as consumer electronic devices, namely, a tablet computer 110 and a smartphone 120, the principles of the present disclosure find application with a wide variety of video exchange devices. The principles of the present disclosure may be integrated into personal computers, dedicated videoconferencing equipment, media players, personal digital assistants, media servers and gaming equipment. Indeed, differences among the types of devices should be considered immaterial unless discussed otherwise herein.

In a video conferencing application, the cameras 112, 142 typically are positioned to capture a scene that includes video conference participants. It often will occur that video conference participants will lack sufficient control over the local environment where the cameras 112, 142 are located to ensure that videoconference participants are included in the field of view generated by their cameras 112, 142 and, more to the point, that non-participates are excluded from the field of view. Embodiments of the present disclosure may apply image composition techniques in the image preprocessors 114 and/or 144 to distinguish videoconference participants from non-participants and to develop a composited video signal based on those distinctions for use in the video conference.

FIG. 2 illustrates a method 200 according to an embodiment of the present disclosure. The method 200 may be employed in the image preprocessor 114 of FIG. 1, the image preprocessor 144 of FIG. 1, or both. The method 200 may operate on a video stream, for example, one that is output from one of the cameras 112, 142 of FIG. 1.

The method 200 may begin by identifying face(s) in the video content (box 210). Thereafter, for each face identified in the video, the method 200 may estimate whether the face's direction of gaze is toward the “camera” (box 220); that is, whether the face's direction of gaze is generally orthogonal to the plane of the display. If the face's direction of gaze is toward the camera, the method 200 may determine that the face is to be included in the content of the video when coded for transmission to a receiver (box 230). If not, the method 200 may determine that the face can be excluded from the content of the video when coded for transmission to the receiver (box 240). After the method 200 selects the faces to be included in the output video, the method 200 may determine a cropping window according to the included faces (box 250). Thereafter, the method 200 may crop the video according to the cropping window (box 260).

Operation of the method 200 is expected to crop video to include faces that are determined to be looking at the camera but exclude of other faces (typically present in background content of the video) that are not looking at the camera. In this manner, the method 200 is expected to yield more aesthetically pleasing video stream because the spatial area of the resultant video focuses on conference participants.

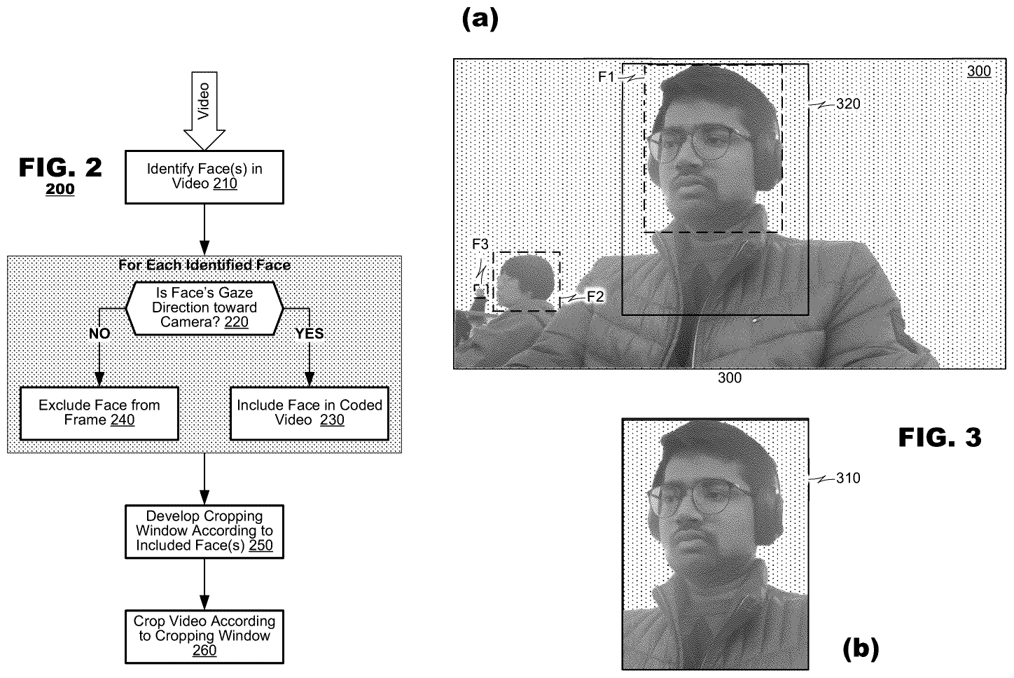

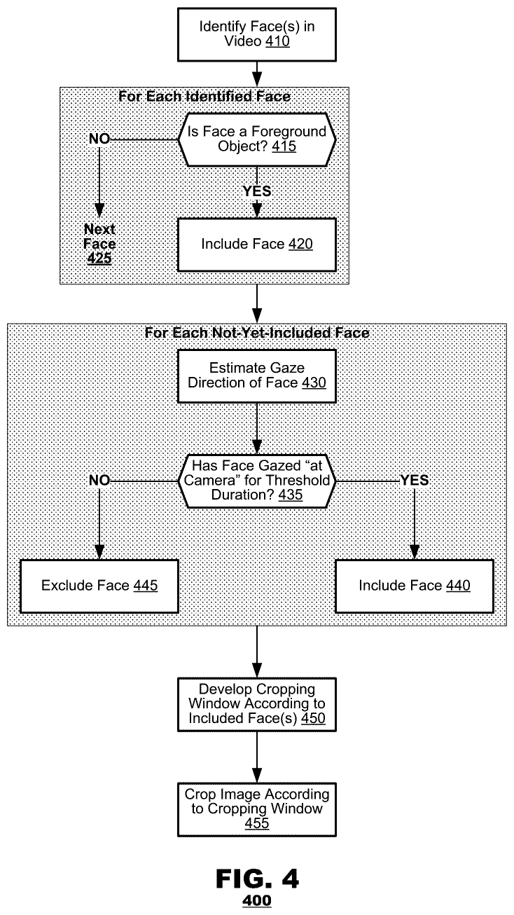

FIG. 3(a) illustrates an exemplary frame 300 of video that may be processed by the method 200 of FIG. 2. FIG. 3(b) illustrates a cropped frame 310 that may be generated from the method 200. FIG. 3 is a mockup in which background image content has been obscured so as to better present certain principles of the present disclosure. As illustrated, the frame content contains image data of three faces F1, F2, and F3.

During operation of the method 200, the method 200 may identify the three faces F1, F2, and F3. By estimating the direction of gaze for each of the three faces, face F1 may be identified as gazing in the direction of the camera, but faces F2 and F3 may be identified as gazing in a direction away from the direction of the camera. From these estimates, the method 200 may develop a cropping window 320 according to the face F1 that is determined to be facing toward the camera. The cropping window 320 may defined to include the spatial area occupied by the selected face F1 and expanded to include other image content that may be deemed appropriate for inclusion. For example, an image preprocessor 114 (FIG. 1) may place a cropping window around a selected face F1 according to a rule of thirds in which the face's eyes are aligned vertically within a cropping window with a horizontal line placed approximately ⅓ from the top edge of the cropping window. Alternatively, the image processor 114 may perform other object recognition on the video and place a cropping window about the selected face(s) so that a predetermined portion of the subjects' bodies are included in the cropping window 320.

The method 200 may operate iteratively on a sequence of frames output by a camera 112 (FIG. 1). It may occur that video conference participants will at times look toward the camera and away from the camera as they participate in a video conference. The cropping window may be altered throughout a video sequence to account for changing directions of gaze and moving locations of detected faces. In an embodiment, faces may be selected and/or deselected for inclusion in a cropping window with a predetermined amount of latency to avoid abrupt changes in locations of the cropping window throughout a sequence. Moreover, as cropping windows expand and/or shrink within a field of view of a video sequence, changes to the cropping window's location and size may be distributed over time to effect smooth transitions in these locations and/or size.

FIG. 4 illustrates a method 400 according to another embodiment of the present disclosure. Here, also, the method 400 may be employed in the image preprocessor 114 of FIG. 1, the image preprocessor 144 of FIG. 1, or both. The method 400 may operate on a video stream, for example, one that is output from one of the cameras 112, 142 of FIG. 1.

The method 400 may begin by identifying face(s) in the video content (box 410). Thereafter, for each face identified in the video, the method 400 may estimate whether the face is a foreground object in video (box 415). If so, the method 400 may determine that the face is to be included in the output video (box 420). If not, the method 400 may advance to another iteration (arrow 425).

Thereafter, for each face identified in box 410 that has not yet been selected for inclusion in the output video, the method 400 may estimate a gaze direction of the face (box 430). The method 400 may determine whether the face's gaze has been directed to the “camera” for at least a threshold amount of time (box 435). If so, then the method 400 may determine to include the face in the output video (box 440). If not, the face need not be included in the output video (box 445).

After the method 400 selects the faces to be included in the output video, the method 200 may determine a cropping window according to the included faces (box 450). Thereafter, the method 400 may crop the video according to the cropping window (box 460).

The threshold amount of time applied in box 435 may be tuned to suit individual application needs. For example, in a video conferencing application, the threshold time may be set to one second. If a detected face has a gaze direction at the camera for one second or longer, it may be categorized as a face to be included within a cropping window. The same (or separate) threshold amount of time may be applied in the method 400 to determine when an included face gazes away from the camera and no longer should be included in a cropping window. Moreover, in an aspect, if the method 400 determines that a single face gazes toward the camera and away from the camera for a predetermined number of times, the threshold amount of time may be prolonged to avoid repeated changes of cropping window.

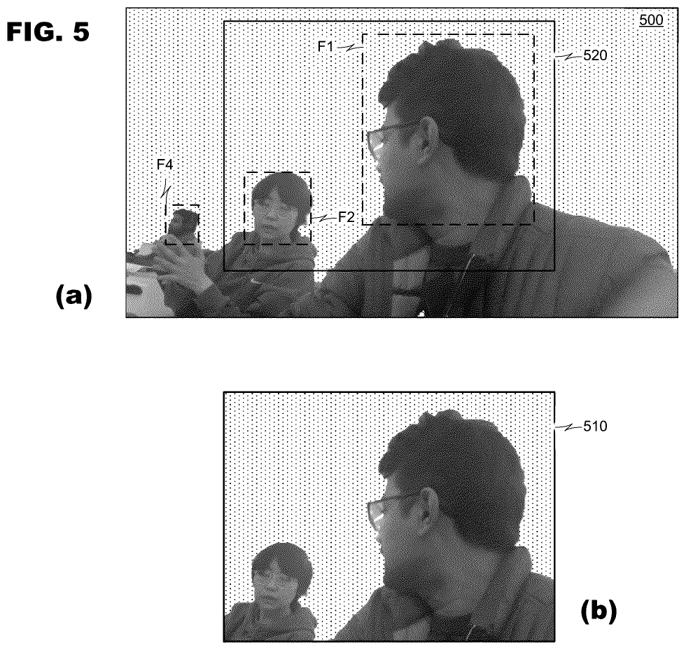

FIG. 5(a) illustrates an exemplary frame 500 of video that may be processed by the method 400 of FIG. 4. FIG. 5(b) illustrates a cropped frame 510 that may be generated from the method 400. FIG. 5 is a mockup in which background image content has been obscured so as to better present certain principles of the present disclosure. As illustrated, the frame content contains image data of three faces F1, F2, and F4.

During operation of the method 400, the method 400 may identify the three faces F1, F2, and F4. The method 400 may estimate that the face F1 is a foreground object. Foreground object detection may be performed based on the face's relative size within the frame 500 based on an estimate of the face's distance from a camera, a motion flow analysis that compares its motion to other image elements (such as background content), or other foreground estimation techniques. In this example, frames F2 and F4 may not be identified as foreground objects. Thus, through operation of boxes 415-420 (FIG. 4), face F1 may be selected for inclusion in output video regardless of any direction of gaze that face F1 may have.

Estimates of gaze direction for faces F2 and F4 may be performed in box 430 (FIG. 4), which may lead to decisions either to select or exclude a face from inclusion in output video. In this example, face F2 may be identified as having a gaze direction that looks at the camera and F4 may be estimated as having a gaze direction that looks away from the camera. Thus, a cropping window 520 may be defined to include the spatial area occupied by the selected faces F1, F2. As in the example of FIG. 3, the cropping window may be and expanded to include other image content that may be deemed appropriate for inclusion.

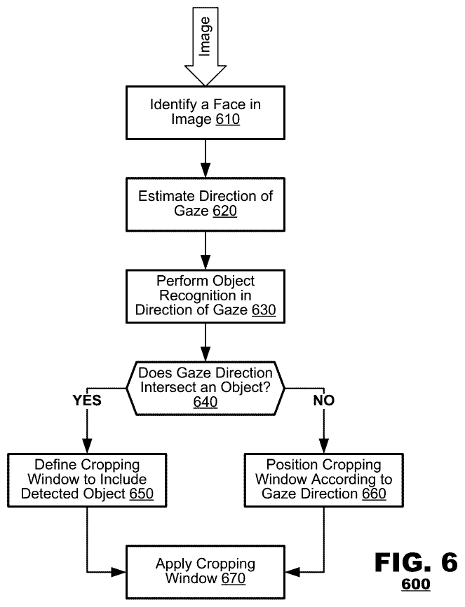

FIG. 6 illustrates another method 600 according to an embodiment of the present disclosure. The method 600 may be employed in the image preprocessor 114 of FIG. 1, the image preprocessor 144 of FIG. 1, or both. The method 600 may operate on a single image, for example, one that is output from one of the cameras 112, 142 of FIG. 1 or retrieved from storage (not shown).

The method 600 may begin by identifying face(s) within the image (box 610). The method 600 may identify a direction of gaze for one or more of the faces (box 620). The method 600 then ma perform object recognition on the image in a region of the image that corresponds to the direction of gaze (box 630). If the method detects an object within the direction of gaze (box 640), the method 600 may define a cropping window for the image that includes both the face and the detected object (box 650). If not, the method 600 may position the cropping window according to the direction of gaze (box 660).

When multiple faces are detected in an image, the operation of boxes 630-670 may be performed with respect to a single face selected from among the multiple faces. For example, the method 600 may select one of the faces closest to a center or a centerline of the image as a primary face whose gaze direction is used for object detection. Alternatively, when multiple faces are detected, the method 600 may define an image region on which to perform object detection from a comparison of the directions of gaze. For example, if several faces have directions of gaze that overlap each other, the object detection may be performed over a region in which the direction of gaze overlap or are consistent.

When a cropping window is defined to include both a face and a detected object, the cropping window may be expanded to include other content of the image as may be appropriate. Again, a cropping window may be defined in accordance with one or more compositional rules such as the rule of thirds. In such applications, the area of the cropping window may be drawn such that a detected face is placed at a location corresponding to a vertical or horizontal line placed approximately ⅓ from a first edge of the cropping window and the detected object is placed at a location corresponding to a vertical or horizontal line placed approximately ⅓ from an opposite edge of the cropping window.

Cropping windows may be defined using other compositional rules. For example, in a scenario in which multiple faces are detected but only a single face is selected for purposes of object detection, a cropping window may be defined to include those other faces from the image. Alternatively, cropping windows may be defined to include faces that can be classified as being placed within a foreground of the image to the exclusion of other faces that would be classified as in a background. And, of course, a cropping window may be defined to include other faces having a gaze direction directed either toward a camera or in a direction of gaze consistent with a primary face of the image, regardless of whether those other faces are used for purposes of object detection.

When a cropping window is defined for a face when no object is detected within the direction of gaze, the cropping window again can follow predetermined compositional rules. Again, the cropping window may be defined to follow the rule of thirds, where the detected face is placed at a location corresponding to a vertical or horizontal line placed approximately ⅓ from a first edge of the cropping window. In this embodiment, the face may be placed such that the direction of gaze is directed to a vertical or horizontal line placed approximately ⅓ from an opposite edge of the cropping window. In this manner, the cropping window is likely to retain much of the image content to which subject of the image (the face) is looking.

FIG. 7 is a block diagram of processing infrastructure of a terminal 700 according to an aspect of the present disclosure. The infrastructure illustrated in FIG. 7 may be employed in either of the terminals 110, 120 of FIG. 1. The terminal 700 may include one or more processors 710, a memory system 720, and input/output devices 730.

The processors 710 may include one or more central processing units 712, a neural network processor 714, an image signal processor 716 and, optionally, a codec 718. The central processing units 712 may control overall operation of the terminal. For example, it may execute program instructions corresponding to a terminal operating system 722 and various application programs 724 (including for, example, video conferencing applications). The video encoders 116 and video decoders 154 (FIG. 1) may be integrated into a processing device 718 such as a digital signal processor or application-specific integrated circuit or into program instructions 726.

All program instructions 722, 724, 726 may be stored in the memory system 720 for execution by the processors 710. The memory system 720 typically includes a hierarchy of memory devices, which may include electrical-, optical- and/or magnetic storage systems.

The input/output devices 730 may include terminal cameras 732, transceiver (TX/RX) devices 734, and display devices 736. In many applications, a single terminal 700 may have multiple cameras (not shown) that may capture local image content. Processors 710 may select camera(s) to provide video for processing in a video conference under program control. Moreover, when multiple cameras each provide image content representing a common field of view, the processors 710 may synthesize a single video from the outputs of these multiple cameras, which may be processed as discussed in the foregoing embodiments.

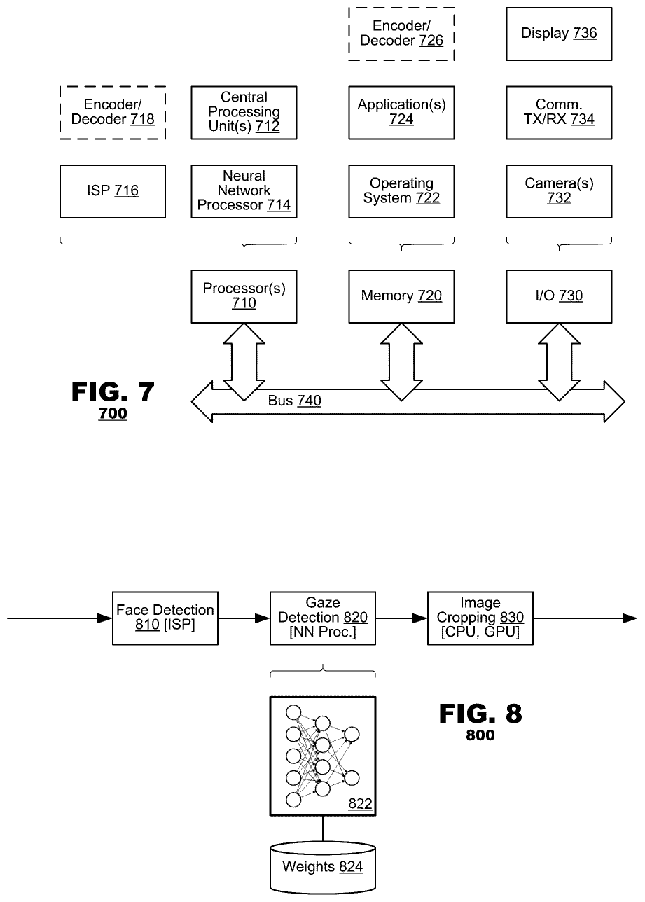

FIG. 8 illustrates a processing pipeline 800 that video may traverse among the processors 710 (FIG. 7) to perform operations described with respect to FIGS. 2, 4, and 6. In an aspect, face detection may be performed by an image signal processor 810 of the terminal 800 (element 716 in FIG. 7). Gaze detection may be performed by a trained neural network processor 820 (element 714 in FIG. 7). The neural network processor 820 may perform processing operations modeled as an array of neurons 822 in which inter-neuron weights 824 are developed that cause the neural network processor 820 to determine gaze direction from image data representing human faces. The weights 824 may be developed from training that is performed on training images, which may be provided to the terminal 800 during provisioning or updating. The image cropping and coding may be performed by a CPU or a graphics processing unit 730 of the terminal.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS memory, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the present disclosure.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

We claim:

1. A method, comprising:
performing face detection on an image,
determining a gaze direction within image content associated with a detected face;
defining a cropping window for the image based on the detected face and the determined gaze direction of the detected face; and
cropping the image according to the cropping window.

2. The method of claim 1, wherein the cropping window is defined to include the detected face in the cropping window when the gaze direction is estimated to be directed to a camera from which the image was derived.

3. The method of claim 1, wherein the cropping window is defined to exclude the detected face from the cropping window when the gaze direction is estimated not to be directed to a camera from which the image was derived.

4. The method of claim 1, further comprising:
performing object detection in a region of the image corresponding to the direction of gaze, and
when an object is detected within the region, the cropping window is defined to include the detected face and the detected object.

5. The method of claim 1, further comprising:
performing object detection in a region of the image corresponding to the direction of gaze, and
when an object is not detected within the region, the cropping window is defined to place the detected face in an off center region of the cropping window with the region placed in a center of the cropping window.

6. A method, comprising:
identifying face(s) from a stream of video;
for each identified face:
determining a gaze of direction of the respective face;
determining whether the respective face is to be included in a cropping window based on its determined gaze of direction; and
cropping frames of the video based on positions of the face(s) determined to be included in the cropping window.

7. The method of claim 6, wherein the cropping window circumscribes all faces determined to be included in the cropping window.

8. The method of claim 6, further comprising, identifying face(s) located within a foreground location of the video, wherein the face(s) determined to be in the foreground location are determined to be included in the cropping window regardless of the respective face's gaze of direction.

9. The method of claim 6, wherein one of the detected face are determined to be included in a cropping window only after its gaze direction looks at a camera that captured the video for a threshold amount of time.

10. The method of claim 6, wherein one of the detected face are determined not to be included in a cropping window after its gaze direction looks away from a camera that captured the video for a threshold amount of time.

11. The method of claim 6, further comprising, following the cropping, transmitting the cropped video to a distant terminal device.

12. The method of claim 6, further comprising, following the cropping, transmitting the cropped video in a videoconference stream.

13. An image processing method, comprising:
performing face recognition on an image,
performing object recognition on the image;
estimating a gaze direction of a detected face,
determining whether a recognized object is present in a region aligned with the gaze direction,
if so, defining a cropping window to include the detected face and the recognized object.

14. The method of claim 13, further comprising, if a recognized object is not present in the region aligned with the gaze direction, defining a cropping window to include the detected face an at least a portion of the region aligned with the gaze direction, the detected face placed off-center within the cropping window and the region aligned with the gaze direction place in a center area of the cropping window.

15. The method of claim 13, wherein the detected face is placed in the cropping window according to a compositional rule.

16. The method of claim 13, wherein the recognized object is placed in the cropping window according to a compositional rule.

17. A system comprising:
a processing system, including a first processor and a second processor, the first processor being a neural network processor trained to estimate gaze direction of face(s) detected from image data, the second processor to execute program instructions stored in a memory device;
the memory device, storing the program instructions that, when executed by the second processor, cause the second processor to:
define a cropping window for an image based on a direction of gaze identified by the first processor for a detected face; and
crop the image according to the cropping window.

18. The system of claim 17, further comprising an image signal processor having an output for identification of face(s) in the image data.

19. The system of claim 17, wherein the program instructions cause the cropping window to be defined to include the detected face in the cropping window when the gaze direction is estimated to be directed to a camera from which the image was derived.

20. The system of claim 17, wherein the program instructions cause the cropping window to be defined to exclude the detected face from the cropping window when the gaze direction is estimated not to be directed to a camera from which the image was derived.

21. The system of claim 17, wherein the program instructions cause the second processor to:
perform object detection in a region of the image corresponding to the direction of gaze, and
when an object is detected within the region, define the cropping window to include the detected face and the detected object.

22. The system of claim 17, wherein the program instructions cause the second processor to:
perform object detection in a region of the image corresponding to the direction of gaze, and
when an object is not detected within the region, define the cropping window to place the detected face in an off center region of the cropping window with the region placed in a center of the cropping window.
